(19) United States
(12) Patent Application Publication
(10) Pub. No.: US 2018/0152735 A1
(43) Pub. Date: May 31, 2018

(54) IMAGE PROCESSING DEVICE FOR REDUCING BLOCK ARTIFACTS AND METHODS THEREOF

(71) Applicant: Daegu Gyeongbuk Institute of Science and Technology, Dalseong-gun (KR)

(72) Inventors: Min Kook CHOI, Dalseong-gun (KR); Soon KWON, Dalseo-gu (KR); Jin Hee LEE, Dalseong-gun (KR); Woo Young JUNG, Dalseo-gu (KR); Hee Chul JUNG, Dalseong-gun (KR)

(21) Appl. No.: 15/718,174

(22) Filed: Sep. 28, 2017

(30) Foreign Application Priority Data
Nov. 30, 2016 (KR) 10-2016-0161798

(51) Int. Cl. H04N 19/86; G06K 9/62; H04N 19/136; H04N 19/172

(52) U.S. Cl. CPC H04N 19/86; H04N 19/172; H04N 19/136; G06K 9/6202

(57) ABSTRACT

An image processing method of an image processing device is provided. The image processing method includes obtaining a plurality of encoded images by each encoding an input image including a plurality of frames at different bitrates; identifying block artifacts from the frames of each of the plurality of encoded images; and generating an output image by selectively combining the frames having minimum block artifacts among the frames of each of the plurality of encoded images based on density of the block artifacts of each of the plurality of encoded images. Accordingly, it is possible to optimize image quality relative to data capacity.

### CROSS-REFERENCE TO RELATED APPLICATIONS

This application claims priority from Korean Patent Application No. 10-2016-0161798, filed on Nov. 30, 2016, in the Korean Intellectual Property Office, the disclosure of which is incorporated herein by reference in its entirety.

### BACKGROUND OF THE INVENTION

### Field of the Invention

Apparatuses and methods consistent with the present disclosure relate to an image processing device for improving image quality and a method thereof, and particularly, to an image processing device for improving image quality by reducing block artifacts of an input image and a method thereof.

### Description of the Related Art

In accordance with the development of an electronic technology, various types of electronic devices have been developed and popularized. In particular, various electronic devices such as a TV, a PC, a cellular phone, a tablet PC, a kiosk, a set-top box, and the like capable of playing back and outputting multimedia data have been used.

The multimedia data such as a still image or a moving image is transmitted to a playback device in an encoded state, and the playback device decodes and outputs the multimedia data. In the case of a moving image formed of a plurality of frames, the encoding is generally performed at the same bitrate for overall frames configuring the moving image. The bitrate refers to a throughput per second. The bitrate may be determined depending on a playback device to play back the image, a bandwidth of a network through the image is to be transmitted, or other service environments. In a case in which the bitrate is low, data capacity is reduced while image quality of each of the frames is deteriorated. On the other hand, in a case in which the bitrate is high, the data capacity is increased while the image quality of each of the frames becomes good.

In a case in which resolution supported by the playback device is very high or the bandwidth of the network is close to infinity, the bitrate of the encoding may be increased to provide data having good image quality. In most cases, however, since the image should be provided using limited resources, the determination of the bitrate of the encoding may be varied depending on the kind of services or a playback environment of a user.

Meanwhile, the playback device that receives the multimedia data decodes and outputs the multimedia data. In this case, block artifacts may be included in the frame due to quantization error caused during the encoding. The block artifact means that some pixels of pixels configuring the frame are displayed differently from an original pixel value. Such a block artifact may be one of causes of causing a viewer to feel that the image quality was degraded.

Therefore, there is a need for a technology capable of reducing the block artifacts.

### SUMMARY OF THE INVENTION

Exemplary embodiments of the present disclosure overcome the above disadvantages and other disadvantages not described above. Also, the present disclosure is not required to overcome the disadvantages described above, and an exemplary embodiment of the present disclosure may not overcome any of the problems described above.

The present disclosure provides an image processing device and a method thereof capable of reducing block artifacts by adaptively selecting a bitrate.

According to an aspect of the present disclosure, an image processing method includes obtaining a plurality of encoded images by each encoding an input image including a plurality of frames at different bitrates; identifying block artifacts from the frames of each of the plurality of encoded images; and generating an output image by selectively combining the frames having the minimum block artifacts among the frames of each of the plurality of encoded images based on density of the block artifacts of each of the plurality of encoded images.

The identifying of the block artifacts from the frames of each of the plurality of encoded images may include identifying a group of pixels which are in the same range as block artifact candidates by comparing pixels of the frames of each of the plurality of encoded images with each other in a vertical or horizontal direction; generating a block artifact map based on the block artifact candidates identified from the respective frames; and identifying the block artifacts by excluding a pixel portion that configures an object among the block artifact candidates based on the block artifact map.

The generating of the output image may include calculating a block artifact density function of each of the plurality of encoded images; calculating a plurality of scaled density functions by performing a scaling that minimizes a difference between the block artifact density functions; and generating the output image including combined frames by selectively combining the frames having the minimum block artifacts among the frames of each of the plurality of encoded images based on the plurality of scaled density functions.

According to another aspect of the present disclosure, an image processing device includes a storage configured to store an input image including a plurality of frames; and a processor configured to process the input image and to generate an output image. The processor may obtain a plurality of encoded images by each encoding the input image at different bitrates, identify block artifacts from frames of each of the plurality of encoded images, and generate the output image by selectively combining the frames having the minimum block artifacts among the frames of each of the plurality of encoded images based on density of the block artifacts of each of the plurality of encoded images.

The processor may identify a group of pixels which are in the same range as block artifact candidates by comparing pixels of the frames of each of the plurality of encoded images with each other in a vertical or horizontal direction, generate a block artifact map based on the block artifact candidates identified from the respective frames, and identify the block artifacts by excluding a pixel portion that configures an object among the block artifact candidates based on the block artifact map.

The processor may calculate a block artifact density function of each of the plurality of encoded images, calculate a plurality of scaled density functions by performing a scaling that minimizes a difference between the block artifact density functions, and generate the output image including combined frames by selectively combining the frames having the minimum block artifacts among the frames of each of the plurality of encoded images based on the plurality of scaled density functions.

A program for implementing the image processing method may be recoded in a non-transitory computer recordable medium.

According to the diverse exemplary embodiments of the present disclosure, it is possible to effectively reduce the block artifacts while having the appropriate data size.

### BRIEF DESCRIPTION OF THE DRAWING FIGURES

The above and/or other aspects of the present disclosure will be more apparent by describing certain exemplary embodiments of the present disclosure with reference to the accompanying drawings, in which:

FIG. 1 is a flowchart for illustrating an image processing method according to an exemplary embodiment of the present disclosure.

FIG. 2 is a block diagram illustrating a configuration of an image processing device according to an exemplary embodiment of the present disclosure.

FIG. 3 is a block diagram for illustrating detailed operations of the image processing method according to an exemplary embodiment of the present disclosure.

FIGS. 4A and 4B are views illustrating examples of a block artifact candidate identified from one frame.

FIGS. 5A to 6B are views illustrating examples of a block artifact map.

FIG. 7 is a view illustrating a result of extracting block artifact density functions according to an exemplary embodiment of the present disclosure.

FIG. 8 is a view illustrating a result of scaling density functions of FIG. 7.

FIG. 9 is a view illustrating an experimental result for measuring block artifact removal performance for each of file sizes and kinds.

FIG. 10 is a view comparing the block artifact removal performance with an MSU deblocking algorithm according to an exemplary embodiment of the present disclosure.

### DETAILED DESCRIPTION OF THE EXEMPLARY EMBODIMENTS

Hereinafter, exemplary embodiments of the present disclosure will be described in detail with reference to the accompanying drawings. Like reference numerals or signs presented in the respective drawings indicate parts or components that perform substantially the same function.

Terms including ordinal numbers such as ‘first’, ‘second’, etc., may be used to describe various components, but the components are not limited by the terms. The terms are only used to distinguish one component from the others. For example, the ‘first’ component may be named the ‘second’ component and the ‘second’ component may also be similarly named the ‘first’ component without departing from the scope of the present disclosure. A term ‘and/or’ includes a combination of a plurality of related items or any one of the plurality of related items.

The terms used in the present specification are used to describe exemplary embodiments and are not intended to limit and/or to restrict the present disclosure. Singular forms include plural forms unless interpreted otherwise in a context. In the present specification, it will be understood that the terms “comprises” or “have” specify the presence of stated features, numerals, steps, operations, components, parts, or a combination thereof, but do not preclude the presence or addition of one or more other features, numerals, steps, operations, components, parts, or a combination thereof.

Like reference numerals present in the respective drawings denote members that perform substantially the same function.

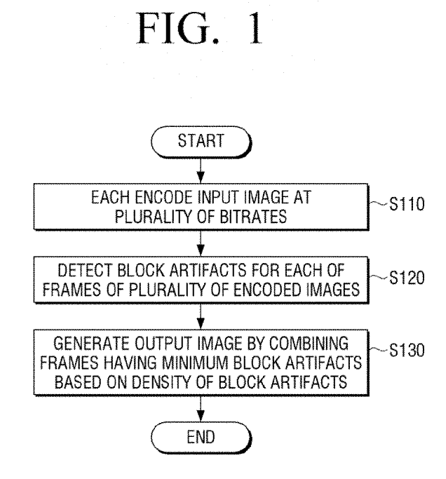

FIG. 1 is a flowchart for illustrating an image processing method according to an exemplary embodiment of the present disclosure. An image processing method of FIG. 1 may be performed in an image processing device capable of processing a moving image including a plurality of frames. The image processing device may be variously implemented such as a TV, a set-top box, a server device, a broadcasting camera, an encoding device, an encoding chip, and the like. In the present specification, the above-mentioned devices are referred to as an image processing device for convenience of explanation.

Referring to FIG. 1, the image processing device each encodes an input images at a plurality of bitrates (S110) The input image may be an image received from an external device by the image processing device or an image read from a storage medium by the image processing device. The image processing device encodes the input image sequentially or in parallel at various bitrates to obtain a plurality of encoded images.

The image processing device identifies (or detects) block artifacts from each frame of the plurality of encoded images (S120). The image processing device analyzes a value of a pixel variation of the respective pixels in the frame to determine whether or not the pixels in the same range are consecutively distributed. In this case, for more accurate determination, the image processing device may also create a block artifact map. In the case of utilizing the block artifact map, it may be prevent that objects which are originally included in the image are determined as the block artifacts. A method of utilizing the block artifact map will be again described below in detail.

In a case in which the block artifacts are identified, the image processing device may generate an output image by combining the frames having a minimum block artifact among the frames of the plurality of encoded images based on density of the block artifacts (S130). For example, when frames configuring a first encoded image are P1-1, P2-1, P3-1, ˜ ˜ ˜, Pn-1, frames configuring a second encoded image are P1-2, P2-2, P3-2, ˜ ˜ ˜, Pn-2, frames configuring a third encoded image are P1-3, P2-3, P3-3, ˜ ˜ ˜, Pn-3, the block artifacts of the first encoded image are minimum in P1, P3, and P6 frames, the block artifacts of the second encoded image are minimum in P4 and P5, and the block artifacts of the third encoded image are minimum in P2, the frames of the output image may be combined in a form such as P1-1, P2-3, P3-1, P4-2, P5-2, and the like.

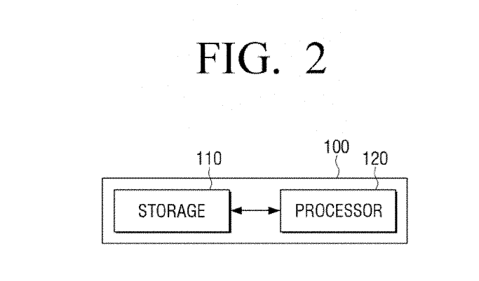

FIG. 2 is a block diagram illustrating a configuration of an image processing device according to an exemplary embodiment of the present disclosure. Referring to FIG. 2, the image processing device 100 includes a storage 110 and a processor 120.

The storage 110 is a component for storing the input image including the plurality of frames. The processor 120 processes the input image stored in the storage 110 and generates the output image. Although not illustrated in FIG. 2, the image processing device may further include various additional configurations such as an input and output interface, a communicator, an audio processor, a display, and the like, depending on the kind of the image processing device.

The processor 120 each encodes the input image stored in the storage 110 at different bitrates to obtain the plurality of encoded images, and identifies the block artifacts from the frames of each of the plurality of encoded images. The processor 120 generates the output image by selectively combining the frames having the minimum block artifact, based on density of the block artifacts of each of the plurality of encoded images.

The processor 120 may display the generated output image by providing the generated output image to the external device, or directly display the generated output image through a display embedded in the image processing device.

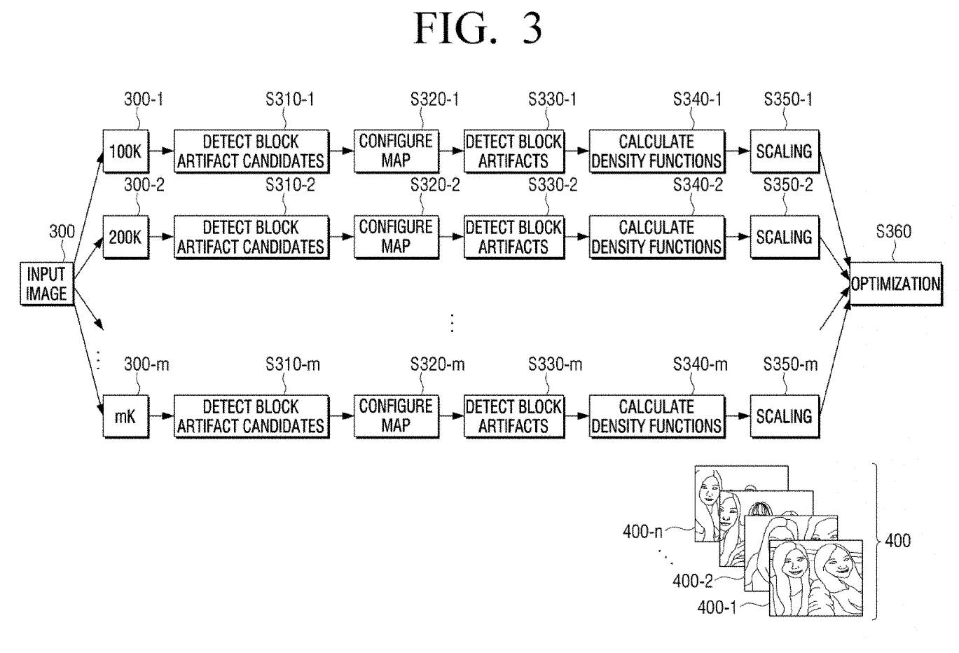

FIG. 3 is a block diagram for illustrating detailed configurations of the image processing method according to an exemplary embodiment of the present disclosure. Referring to FIG. 3, an input image 300 is each encoded at a plurality of bitrates 100 k to mk. Accordingly, a plurality of encoded images 300-1 to 300-m are obtained.

For example, in a case in which an encoding of an input image including k sheets of frames f is performed at h different bitrates for V={f⁽¹⁾, f⁽²⁾, . . . , f^{(k)}},
a set v of h encoded images may be obtained. v may be expressed as v∈{v₁, v₂, . . . , vₕ}.

The image processing device identifies pixel groups having high possibility of the block artifact as block artifact candidates from the respective frames of the obtained encoded image (S310-1 to S310-m). For example, the image processing device identifies a candidate group of the block artifacts by identifying whether or not consecutive distributions of 1-D pixel variation in vertical and horizontal directions, respectively, are the same as each other.

When an i-th frame of a j-th element of an encoding set v generated for the input image V, that is, a j-th encoded image vⱼ is f⁽ⁱ⁾, a first-order differential image for f(i) in the horizontal and vertical directions may be expressed as (fₓ⁽ⁱ⁾, f_{y}⁽ⁱ⁾). In this case, a value of the pixel variation at a pixel position (u,v) may be defined as Mathematical Expression 1 below.

fₓ⁽ⁱ⁾=f⁽ⁱ⁾(u,v)−f⁽ⁱ⁾(u+1,v)

f_{y}⁽ⁱ⁾=f⁽ⁱ⁾(u,v)−f⁽ⁱ⁾(u,v+1) [Mathematical Expression 1]

The image processing device calculates 1-D variation vectors having a size of s (the number of consecutive pixels with the same intensity which form the boundary of a visible block that has been identified) from a specific pixel position (u,v) at all pixel positions to identify whether or not the consecutive distributions of the pixel variation are the same as each other. The 1-D variation vectors may be defined as Mathematical Expression 2 below.

vₓ(u,v)=[Δₓ¹,Δₓ², . . . ,Δₓ^{s}]^{T}

v_{y}(u,v)=[Δ_{y}¹,Δ_{y}², . . . ,Δ_{y}^{s}]^{T} [Mathematical Expression 2]

A variation identifying function is defined as fₓ⁽ⁱ⁾→Wₓ⁽ⁱ⁾, where Wₓ⁽ⁱ⁾ is defined as a three-dimensional tensor mapping to the identifying function from the i-th frame.

Here, a data matrix D⁽ⁱ⁾ is a limiting condition at the pixel position (u,v) of W⁽ⁱ⁾, and is defined as Mathematical Expression 3 below.

$${W}_{x}^{( i )} ( u , v ) \text{:} {D}_{x}^{( i )} ( u , v ) = \{ \begin{matrix}1 , & if {Δ}_{x}^{1} = {Δ}_{x}^{2} = … = {Δ}_{x}^{s} \\ 0 , & otherwise\end{matrix} , \\ s . t . {v}_{x} ( u , v ) \neq 0. \qquad [ Mathematical Expression 3 ]$$

Mathematical Expression 3 represents formula of finding possibility in the horizontal direction. After the possibility in the vertical direction is found in the same way, D⁽ⁱ⁾(u, v) representing possibility that the pixel at (u,v) is the block artifact is a value that the possibility in the vertical direction and the possibility in the horizontal direction are summed. Here, D⁽ⁱ⁾(u,v) is given as a binary matrix and has the same size as f⁽ⁱ⁾.

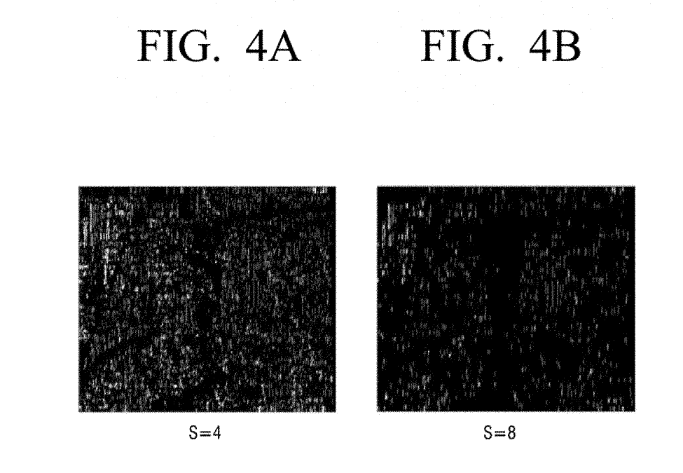

FIGS. 4A and 4B illustrate examples of extracting D_{y}⁽ⁱ⁾(u,v), which are the block artifact candidates in the vertical direction. FIG. 4 illustrates a case in which s is set to 4 and FIG. 4B illustrates a case in which s is set to 8. Points which are brightly displayed in FIGS. 4A and 4B represent the block artifact candidates. It may be seen that as s is set to be larger, the block artifact candidates are reduced.

Referring back to FIG. 3, the image processing device configures a map for each of encoded files by combining the identified block artifact candidates (S320-1 to S320-m). A block artifact map means data from which whether the block artifacts of the respective frames are distributed in any pixel may be confirmed.

When the block artifact map is Cⱼ, Cⱼ is defined as a sum of overall matrixes for a binary matrix set Dⱼ={Dⱼ⁽¹⁾, Dⱼ⁽²⁾, Dⱼ⁽³⁾, . . . , Dⱼ^{(k)}} extracted for a total k sheets of frames of the j-th element vⱼ of v. That is,

$${V}_{j} \text{:} {C}_{j} ( u , v ) = {\sum }_{i - 1}^{k} {D}_{j}^{( i )} ( u , v ) .$$

Cⱼ may be normalized as \tilde{C}ⱼ=Cⱼ/∥Cⱼ∥. The image processing device generates the block artifact set, that is, a block artifact map [symbol] ={\tilde{C}₁, \tilde{C}₂, . . . , \tilde{C}ₕ} by all multi-bitrate video sets v.

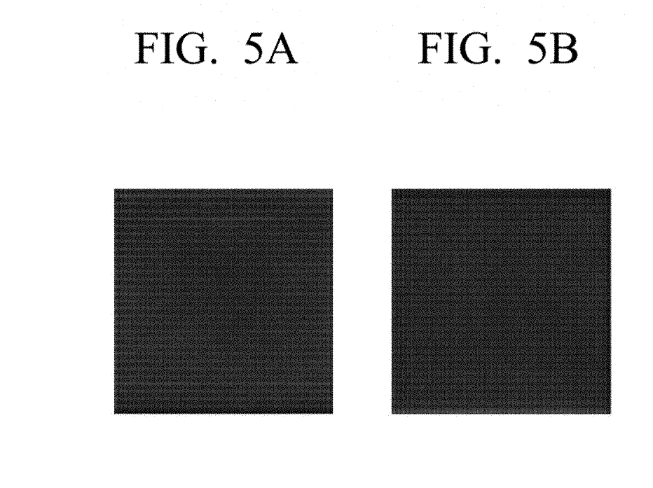

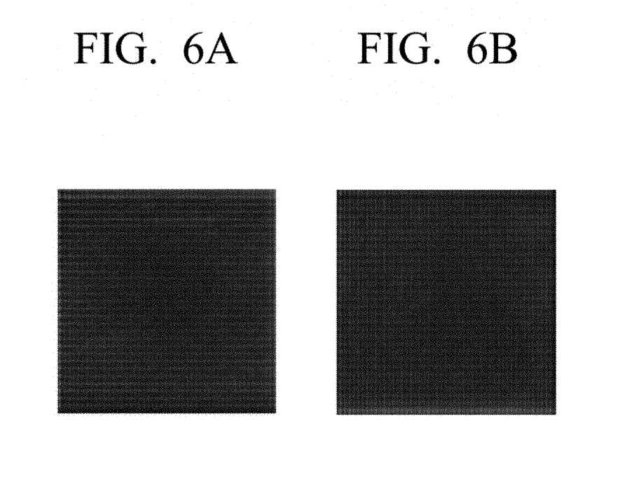

FIGS. 5A to 6B illustrate examples of the normalized block artifact map identified from the input image. FIGS. 5A and 5B illustrate a case in which s is 4 and FIGS. 6A and 6B illustrate a case in which s is 8.

FIGS. 5A and 6A each illustrate the examples of the normalized block artifact map in the horizontal direction obtained from an input video. FIGS. 5B and 6B each illustrate the examples of the normalized block artifact map in the vertical direction obtained from the input video.

As illustrated in FIGS. 5A to 6B, the pixels in which the block artifacts occur may be variously distributed and displayed in the block artifact map. The image processing device may determine whether or not the block artifact candidates of the respective frames are actual artifacts or are objects of an original image, base on the block artifact map. The image processing device identifies the block artifacts by excluding pixel portions that configure the objects from the block artifact candidates depending on a result of the determination (S330-1 to S330-m).

Specifically, in a case in which a normalized accumulated value at any pixel (u,v) position from the normalized block artifact map \tilde{C}ⱼ obtained from vⱼ is a predetermined threshold value p or more, the image processing device extracts the pixel as the block artifact. The image processing device determines the pixels having the normalized accumulated value which is less than the predetermined threshold value as the objects and excludes the pixels from the block artifacts.

As a result, the image processing device may identify a block artifact region Rᵢ of the i-th frame f⁽ⁱ⁾ of the encoded image vⱼ by performing an operation as in Mathematical Expression 4 below.

$${R}_{j} ( u , v ) = \{ \begin{matrix}1 , & if {\tilde{C}}_{j} ( u , v ) > ρ \\ 0 , & otherwise\end{matrix} . \qquad [ Mathematical Expression 4 ]$$

A final block artifact Aⱼ⁽ⁱ⁾ in the i-th frame f⁽ⁱ⁾ of the encoded image vⱼ is defined as Aⱼ⁽ⁱ⁾(u,v)=Dⱼ⁽ⁱ⁾(u,v)∧Aⱼ⁽ⁱ⁾(u,v) from a block artifact candidate group matrix Dⱼ and the block artifact region Rⱼ.

The image processing device obtains a block artifact matrix A from all frames within the encoded image v of overall bitrates for the input image and calculates a block artifact matrix set [symbol] ={A₁, A₂, . . . , Aₕ}.

The image processing device calculates a density function of the block artifacts based on the calculated block artifacts (S34-1 to S340-m). Here, the density function refers to a probability density function.

When the number of block artifacts occurring at the pixel position (u,v) of the specific frame is l(i), the number of block artifacts occurring within the i-th frame may be defined as Σᵤ₌₁^{m}Σᵥ₌₁ⁿA⁽ⁱ⁾(u,v).

The image processing device may obtain a density function Iⱼ=[l₁ⱼ, l₂ⱼ, l₃ⱼ, . . . , lₖⱼ]^{T} for a result provided for all k frames of one encoded image vⱼ.

As a result, the image processing device may generate a set L={l₁, l₂, . . . , lₕ} of the block artifact density function for a set of entire encoded images.

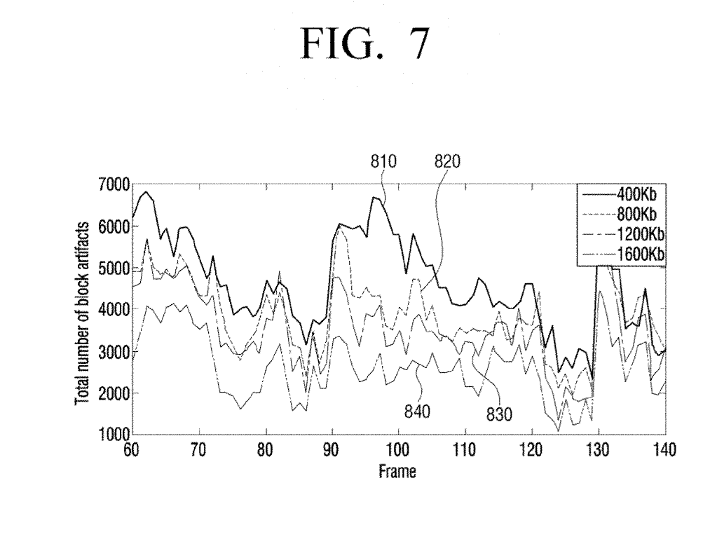

FIG. 7 illustrates a set L of the block artifact density function of 80 frames that belong to the encoded image which is encoded at different bitrate (s=4).

Referring to FIG. 7, the block artifact density functions of the image encoded at a total of four bitrates such as 400 kb, 800 kb, 1200 kb, and 1600 kb are represented by a plurality of graphs 810, 820, 830, and 840. In a graph of FIG. 7, a horizontal axis represents a frame number and a vertical axis represents the number of block artifacts. Referring to FIG. 7, it may be seen that the encoded image having a small bitrate has more block artifacts.

If the density functions are calculated, the image processing device scales the density functions (S350-1, S350-2, ˜ ˜ ˜, S350-m). The scaling means a work of adjusting magnitude of each of the density functions so that a difference between the plurality of density functions is minimized. If the density functions are scaled, it may be identified that which frame may have the minimum number of block artifacts when considering the data size of each frame.

An encoding level of the bitrate may be set based on encoding image quality of the original image. For example, in the case of ordinary HD contents, when 1600 kb/s is set as the maximum bitrate, the ordinary HD contents may keep substantially the same image quality as the original image. Base on the maximum bitrate of 1600 kb/s, other bitrates may be set in at a regular interval. FIG. 7 illustrates a state in which the bitrates are set in stages in a unit of 400 kb, but this is merely illustrative and the bitrates may be set in various ways. In addition, FIG. 7 illustrates the case in which the image is each encoded at the four bitrates, but the image may also be encoded at the various numbers of bitrates (e.g., eight, etc.).

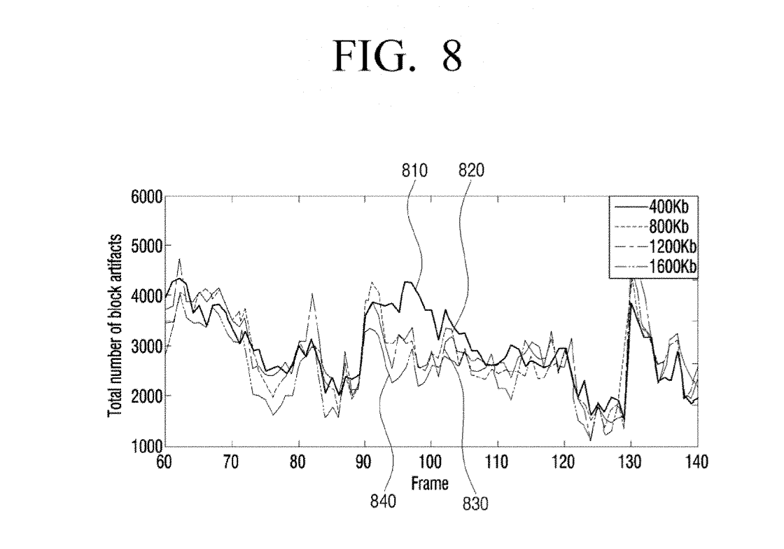

FIG. 8 is a view illustrating a result of scaling the respective density functions of FIG. 7. Referring to FIG. 8, sizes of graphs 810, 820, 830, and 840 of the block artifact density functions of the images encoded at 400 kb, 800 kb, 1200 kb, and 1600 kb are re-adjusted.

An objective function for selecting an optimal bitrate for each frame f⁽ⁱ⁾ from the set L of the density functions may be defined as follows.

$${argmin}_{Λ} {\sum }_{j = 1}^{h - 1} {‖ {l}_{h} - {λ}_{j} {l}_{j} ‖}_{p} \qquad [ Mathematical Expression 5 ]$$

In Mathematical Expression 5, h represents the number of density functions, λⱼ represents a weight variable, and lₕ represents the density function of the encoded image of the maximum bitrate in the set L. For example, when L={l₁, l₂, l₃, l₄} is {400, 800, 1200, 1600}, h is 4, and in the case of l₄, the density function is the density function having the maximum bitrate. In addition, Λ represents a weight vector that minimizes an Lₚ distance between the probability density functions of a j-th result vector Iⱼ modified by the weight variable λⱼ. This may be expressed as Λ=[λ₁, λ₂, . . . , λₕ₋₁]^{T}.

As expressed in Mathematical Expression 5, the objective function is defined as fining the probability density function l of the encoded moving image of the maximum bitrate in the set L, and the weight vector Λ.

An estimation of a solution Λ of the given objective function is to find a scaler λⱼ that minimizes the encoding bitrate versus the block artifacts for the entire input video. The block artifact density function scaled through Λ obtained from the objective function described above may be expressed as L′={l₁′, l₂′, . . . , lₕ′} or L′=Λ^{T}L.

The image processing device may scale the density functions of the respective encoded images by performing the operations based on Mathematical Expressions described above.

If the scaling is completed, the image processing device may perform an optimization work using the scaled density functions. The optimization work means a work that obtains the output image in which the number of block artifacts is maximally reduced while considering the data size. Specifically, the optimization work means a work of generating an output image 400 including combined frames 400-1 to 400-n by selectively combining the frames having the minimum block artifacts among the frames of each of the plurality of encoded images based on the respective scaled density functions.

Specifically, when it is assumed that a j-th element lⱼ′ of an obtained L′ is expressed as a column vector having k elements, the image processing device may calculate a data matrix Q having a size of k*h for selecting the optimal bitrate from iₕ. The matrix Q is expressed as in Mathematical Expression 6 below.

$$Q = [ \begin{matrix}{l}_{11}^{′} & {l}_{12}^{′} & … & {l}_{1 h - 1}^{′} & {l}_{1 h} \\ {l}_{21}^{′} & {l}_{22}^{′} & … & {l}_{1 h - 1}^{′} & {l}_{2 h} \\ ⋮ & ⋮ & ⋱ & {l}_{1 h - 1}^{′} & ⋮ \\ {l}_{k 1}^{′} & {l}_{k 2}^{′} & … & {l}_{1 h - 1}^{′} & {l}_{kh}\end{matrix} ] . \qquad [ Mathematical Expression 6 ]$$

The image processing device extracts a vector including the optimal bitrate from the matrix Q as follows.

$$\hat{l} = {[ {\hat{l}}_{1} , {\hat{l}}_{2} , … , {\hat{l}}_{k} ]}^{T} , \\ {\hat{l}}_{i} = {min}_{{l}^{′ }} {( {q}^{′} )}_{i}^{T} \qquad [ Mathematical Expression 7 ]$$

In Mathematical Expression 7, (q′)ᵢ^{T} means a vector of an i-th row. Finally, a level of the bitrate of an i-th frame is determined as a result value [symbol] obtained by applying a 1-D median filter of a filter size of 5 to a vector value of Mathematical Expression 7 to prevent a sharp change of image quality.

The image processing device may obtain the output image by performing the optimization work in the way as described above. The output image may be transmitted to other modules in the image processing device or external devices and played back.

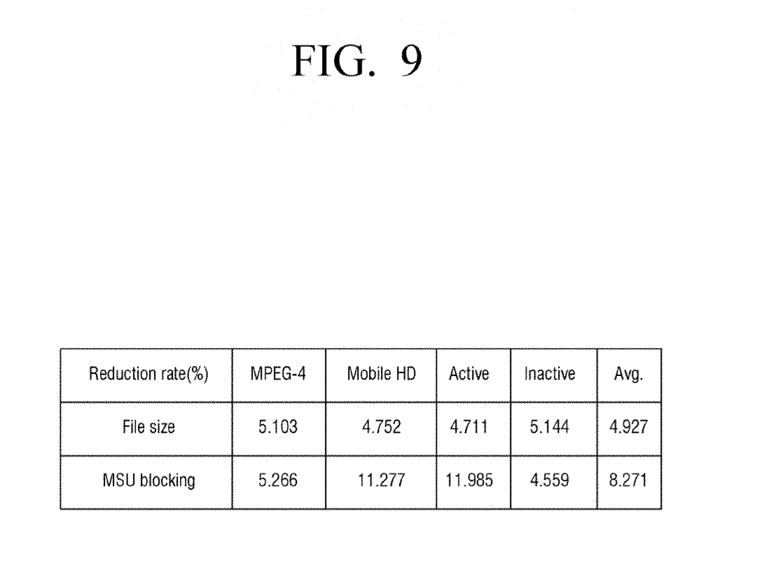

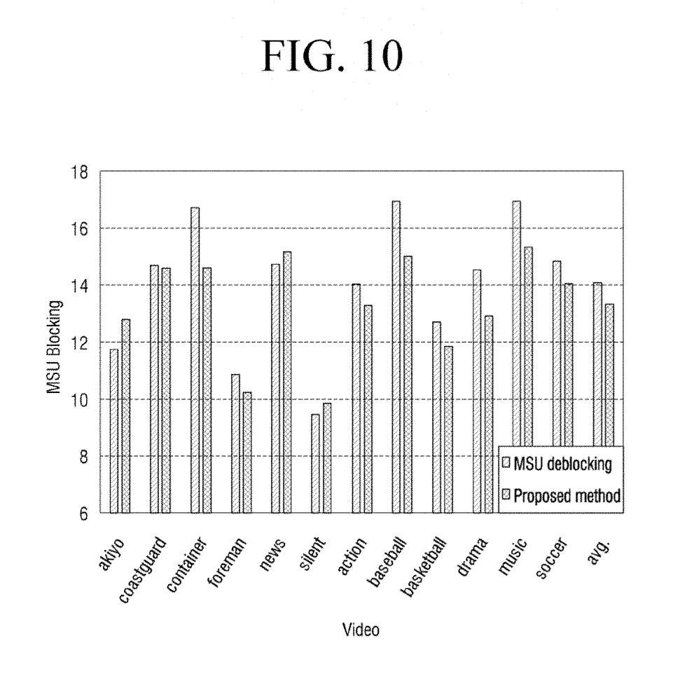

According to the image processing method described above, it is possible to improve the image quality by effectively reducing the number of block artifacts without significantly increasing the file size. FIGS. 9 and 10 are views illustrating such an effect. FIGS. 9 and 10 illustrate results of utilizing a structure similarity based image quality evaluation algorithm and an MSU quantitative evaluation tool.

FIG. 9 illustrates a performance improvement result for a file size and a block artifact removal according to an exemplary embodiment of the present disclosure. Table in FIG. 9 illustrates a performance gain obtained when the image processing method according to an exemplary embodiment of the present disclosure is applied to various files such as MPEG-4, mobile HD, an active image, an inactive image, and the like, in a unit of %. Here, the inactive image means an image that includes many static images, and the active image means an image that includes many motions. The file size represents the extent of a reduction of the file size as compared to a conventional static encoding technique and an MSU blocking represents the extent of a reduction of the block artifacts. Referring to FIG. 9, it may be seen that as many motions are distributed in the image or the image quality is high, a high performance gain is obtained.

FIG. 10 is a view comparing the block artifact removal performance with an MSU deblocking algorithm according to an exemplary embodiment of the present disclosure. Referring to FIG. 10, it may be seen that the number of block artifacts is reduced for various kinds of images as compared to the conventional method.

Referring to FIGS. 9 and 10, the image processing method according to the diverse exemplary embodiments of the present disclosure may obtain the frames encoded at the optimal bitrate for each of the frames. Accordingly, it may be seen that the generated output image has a small file size and the number of block artifacts is reduced.

The exemplary embodiments described above may be variously modified. As an example, although it has been described that the image processing device obtains the plurality of encoded images by directly each encoding the input image at the plurality of bitrates, the image processing device may not also directly perform the encoding operation. Specifically, the image processing device may receive the encoded images encoded at different bitrates from various sources and may also generate the output image using the encoded images.

In addition, the image processing method according to the diverse exemplary embodiments described above may be implemented in a program and may be stored in a non-transitory readable medium.

The non-transitory readable medium is not a medium that stores data for a short period of time, such as a register, a cache, a memory, or the like, but means a medium that semi-permanently stores data and is readable by a device. Specifically, the programs for performing the various methods described above may be provided to be stored in the non-transitory readable medium such as a compact disc (CD), a digital versatile disk (DVD), a hard disk, a Blu-ray disk, a universal serial bus (USB), a memory card, a read-only memory (ROM), or the like.

The non-transitory readable medium may be connected to or mounted in a device having hardware capable of reading and processing data recorded in the medium. The device may implement the image processing method described above by executing the program stored in the non-transitory readable medium. For example, the non-transitory readable medium may be mounted in a TV, a set-top box, a server device, a broadcasting camera, a PC, and the like, but is not necessarily limited thereto.

Hereinabove, although the diverse exemplary embodiments of the present disclosure have been described, the present disclosure is not limited to the certain exemplary embodiments described above. Therefore, the present disclosure may be variously modified by those skilled in the art without departing from the spirit and the scope of the present disclosure. The modifications should not be understood separately from the technical spirit or scope of the present disclosure.

In addition, the description of the exemplary embodiments described above is not intended to limit the scope of the present disclosure, but is intended to be illustrative in order to understand the features of the present disclosure. Therefore, the contents described in the present specification and the following claims, and modified examples equivalent thereto should be construed as being included in the technical spirit of the present disclosure.

What is claimed is:

1. An image processing method of an image processing device, the method comprising:
obtaining a plurality of encoded images by encoding an input image including a plurality of frames at different bitrates;
identifying block artifacts from the frames of each of the plurality of encoded images; and
generating an output image by selectively combining the frames having minimum block artifacts among the frames of each of the plurality of encoded images based on density of the block artifacts of each of the plurality of encoded images.

2. The image processing method as claimed in claim 1, wherein the identifying of the block artifacts from the frames of each of the plurality of encoded images includes:
identifying a group of pixels which are in the same range as block artifact candidates by comparing pixels of the frames of each of the plurality of encoded images with each other in a vertical or horizontal direction;
generating a block artifact map based on the block artifact candidates identified from the respective frames; and
identifying the block artifacts by excluding a pixel portion that configures an object among the block artifact candidates based on the block artifact map.

3. The image processing method as claimed in claim 2, wherein the generating of the output image includes:
calculating a block artifact density function of each of the plurality of encoded images;
calculating a plurality of scaled density functions by performing a scaling that minimizes a difference between the block artifact density functions; and
generating the output image including combined frames by selectively combining the frames having the minimum block artifacts among the frames of each of the plurality of encoded images based on the plurality of scaled density functions.

4. An image processing device comprising:
a storage configured to store an input image including a plurality of frames; and
a processor configured to process the input image and to generate an output image,
wherein the processor obtains a plurality of encoded images by encoding the input image at different bitrates,
identifies block artifacts from frames of each of the plurality of encoded images, and
generates the output image by selectively combining the frames having minimum block artifacts among the frames of each of the plurality of encoded images based on density of the block artifacts of each of the plurality of encoded images.

5. The image processing device as claimed in claim 4, wherein the processor identifies a group of pixels which are in the same range as block artifact candidates by comparing pixels of the frames of each of the plurality of encoded images with each other in a vertical or horizontal direction, generates a block artifact map based on the block artifact candidates identified from the respective frames, and identifies the block artifacts by excluding a pixel portion that configures an object among the block artifact candidates based on the block artifact map.

6. The image processing device as claimed in claim 5, wherein the processor calculates a block artifact density function of each of the plurality of encoded images, calculates a plurality of scaled density functions by performing a scaling that minimizes a difference between the block artifact density functions, and generates the output image including combined frames by selectively combining the frames having the minimum block artifacts among the frames of each of the plurality of encoded images based on the plurality of scaled density functions.

7. A non-transitory computer recordable medium having a program for implementing an image processing method stored thereon, wherein the image processing method includes:
obtaining a plurality of encoded images by each encoding an input image including a plurality of frames at different bitrates;
identifying block artifacts from the frames of each of the plurality of encoded images; and
generating an output image by selectively combining the frames having the minimum block artifacts among the frames of each of the plurality of encoded images based on density of the block artifacts of each of the plurality of encoded images.
